(19) United States
(12) Patent Application Publication
(10) Pub. No.: US 2008/0214721 A1
(43) Pub. Date: Sep. 4, 2008

(54) POLYESTER-POLACRYLATE DISPERSIONS FOR TWO-COMPONENT COATING COMPOSITIONS

(75) Inventors: Rolf Gertzmann, Leverkusen (DE); Martin Melchiors, Leichlingen (DE); Sandra Hackbarth, Bedburg (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/040,972

(22) Filed: Mar. 3, 2008

(30) Foreign Application Priority Data
Mar. 2, 2007 (DE) 102007010614.0

(51) Int. Cl. C08L 67/02

(52) U.S. Cl. 524/513

(57) ABSTRACT

The invention relates to aqueous polyester-polyacrylate dispersions based on copolymers, to a process for their preparation, and to aqueous coating compositions based thereon and the use thereof as lacquers. The dispersions are prepared from a polyester component A) that comprises the reaction product of A1) one or more saturated, aliphatic and/or aromatic di-, tri- or tetra-carboxylic acids or their anhydrides, and A2)one ore more diols and/or polyols, and a polyacrylate component B) that comprises the reaction product of B1) one or more OH-group-free (meth)acrylic acid esters and/or vinyl aromatic compounds, B2) one or more hydroxy-functional vinyl monomers or hydroxy-functional (meth)acrylic acid esters, and B3) one or more acid-group-containing monomers capable of free-radical copolymerisation, herein te polyester component A) has a hydroxyl number of from 180 to 300 mg KOH/g substance and an acid number of from 0.5 to 30 mg KOH/g, and the polyacrylate component B) has a hydroxyl number of from 10 to 180 mg KOH/g and an acid number of from 10 to 100 mg KOH/g, and the copolymer has an OH number smaller than that of the polyester component A) and greater than 27 mg KOH/g.

### CROSS-REFERENCE TO RELATED APPLICATION

This application claims priority under 35 U.S.C. §119 (a-d) to German Application Serial No. 10 2007 010 614.0, filed Mar. 2, 2007.

### FIELD OF THE INVENTION

The invention relates to aqueous polyester-polyacrylate dispersions based on copolymers, to a process for their preparation, and to aqueous coating compositions based thereon and the use thereof as lacquers.

### BACKGROUND OF THE INVENTION

It is known from a large number of publications and patents to use dispersions based on polyacrylate dispersions in water-dilutable lacquers and coating systems.

When applying lacquers to a substrate, air is enclosed in the lacquer film in dissolved form or in the form of microbubbles. As the lacquer dries and solvents and/or water escape, bubbles form or the microbubbles that are present grow. Some of these bubbles dissolve in the lacquer polymer again, others rise to the surface of the lacquer and escape (rise & rupture model). At a particular film thickness, some of the bubbles can no longer escape completely and visible defects in the lacquer film form, such as, for example, blisters, pinholes and craters. The film thickness at which this phenomenon occurs is referred to as the “blister-free layer thickness” or “popping limit”. The blister-free layer thickness is an important quality feature for the processing reliability of a lacquer. The blister-free layer thickness of aqueous two-component (2K) polyurethane (PUR) lacquers according to the prior art is from 60 to 80 μm (see W. Hovestadt & E. Jürgens (1999)—Blasenfreie Applikation wässriger 2K-PUR-Lacke. In: Farbe & Lack 8/99: 30-37 and WO-A 2002/079296). However, in particular when lacquering three-dimensional parts, regions in which lacquer layer thicknesses greater than the mentioned 60 to 80 μm are achieved are always formed as a result of flow effects. When aqueous 2K PUR lacquers according to the prior art are used, blisters can then occur in the lacquer, which lead to noticeable faults in the lacquer surface and hence to a reduction in the quality of the lacquered parts. There was therefore an urgent need for aqueous dispersions which can be processed to 2K PUR lacquers having a higher blister-free layer thickness. These lacquers are to be based on dispersions which, owing to reactive groups, are capable, even at room temperature, of curing to high-quality coatings with suitable crosslinkers. Moreover, the dispersions are to have a high solids content and excellent storage stability, both as a dispersion and as a lacquer. The lacquer films are additionally to exhibit very good resistance properties to solvents, water and environmental influences.

EP-A 0 543 228 describes aqueous two-component (2K) binders composed of polyester-polyacrylate resins containing carboxylate and hydroxyl groups, and polyisocyanates having free isocyanate groups. The advantage of the described coating compositions is that high-quality coatings are provided under practical conditions. In this case, a reaction that takes place during curing of the coating composition between water and the free isocyanate groups is suppressed to such an extent that blister-free coatings can be obtained. However, the systems described in EP-A 0 543 228 no longer meet the demands that are made nowadays in particular in respect of the optical quality and processing reliability of 2K systems. This means that the coatings must not exhibit any defects, for example in the form of blisters or craters. Such defects form, for example, in areas of greater coating thicknesses during the manual application of lacquers.

### SUMMARY OF THE INVENTION

The object of the present invention was, therefore, to provide aqueous copolymer dispersions based on polyester-polyacrylates which can be processed to aqueous 2K PUR lacquers having a higher blister-free layer thickness and which satisfy the properties required above.

It has now been found that lacquer films that comprise aqueous copolymer dispersions based on polyester-polyacrylates as binders and polyisocyanates as crosslinkers can be produced with layer thicknesses of more than 80 μm.

The present invention accordingly provides aqueous copolymer dispersions comprising
a polyester component A) that comprises the reaction product of
A1) one or more saturated, aliphatic and/or aromatic di-, tri- or tetra-carboxylic acids or their anhydrides,
A2) one or more diols and/or polyols,
A3) optionally one or more hydroxycarboxylic acids, lactones, amino alcohols and/or aminocarboxylic acids,
A4) optionally one or more (cyclo)aliphatic, olefinically unsaturated mono- or di-carboxylic acids and/or unsaturated diols and/or polyols,
A5) optionally one or more monocarboxylic acids and/or monoalcohols and a polyacrylate component B) that comprises the reaction product of
B1) one or more OH-group-free (meth)acrylic acid esters and/or vinyl aromatic compounds,
B2) one or more hydroxy-functional vinyl monomers or hydroxy-functional (meth)acrylic acid esters,
B3) one or more acid-group-containing monomers capable of free-radical copolymerisation, and
B4) optionally one or more monomers capable of free-radical copolymerisation other than the compounds of components B1) to B3),
   wherein
the polyester component A) has a hydroxyl number of from 180 to 300 mg KOH/g substance, preferably from 210 to 280 mg KOH/g substance, and an acid number of from 0.5 to 30 mg KOH/g, preferably from 1 to 8 mg KOH/g substance, and the polyacrylate component B) has hydroxyl numbers of from 10 to 180 mg KOH/g, preferably from 40 to 160 mg KOH/g, particularly preferably from 60 to 150 mg KOH/g, and an acid number of from 10 to 100 mg KOH/g, preferably from 15 to 80 mg KOH/g and particularly preferably from 20 to 60 mg KOH/g, and the copolymer has an OH number greater than 27 mg KOH/g.

### DETAILED DESCRIPTION OF THE INVENTION

As used herein in the specification and claims, including as used in the examples and unless otherwise expressly specified, all numbers may be read as if prefaced by the word “about”, even if the term does not expressly appear. Also, any numerical range recited herein is intended to include all sub-ranges subsumed therein.

The polyester component A) is obtained by polycondensation of the structural units A1), A2) and A4) in a manner known per se.

In a further embodiment of the present invention, the polyester component A) contains the structural units A1), A2), A3) and A4) and has a double bond content (calculated as C═C, molar weight 24) of from 0.1 to 3.0%, preferably from 0.2 to 2.0% and particularly preferably from 0.5 to 1.5%.

Component A5) is only an optional structural unit in both embodiments according to the invention.

The preparation of the polyester A) can optionally be carried out with the aid of conventional esterification catalysts, preferably according to the principle of melt or azeotropic condensation at temperatures of from 140 to 240° C. with the removal of water.

Suitable carboxylic acids A1) are dicarboxylic acids and/or anhydrides, for example phthalic acid, phthalic anhydride, isophthalic acid, hexahydrophthalic acid, hexahydrophthalic anhydride, succinic acid, succinic anhydride, adipic acid, dodecanedioic acid, hydrogenated dimer fatty acids and, as carboxylic acids or anhydrides of higher functionality, for example trimellitic acid and trimellitic anhydride, and also mixtures of these compounds. Preference is given to dicarboxylic acids and dicarboxylic anhydrides. Particular preference is given to cyclic dicarboxylic acids, such as phthalic acid, phthalic anhydride, isophthalic acid, hexahydrophthalic acid or hexahydrophthalic anhydride.

Suitable as component A2) are (cyclo)alkanediols (i.e. dihydric alcohols with (cyclo)aliphatically bonded hydroxyl groups) having a molecular weight in the range from 62 to 286 g/mol, such as, for example, ethanediol, 1,2- and 1,3-propanediol, 1,2-, 1,3- and 1,4-butanediol, 1,5-pentanediol, 1,6-hexanediol, neopentyl glycol, cyclohexane-1,4-dimethanol, 1,2- and 1,4-cyclohexanediol, 2-ethyl-2-butylpropanediol, diols containing ether oxygen, such as, for example, diethylene glycol, triethylene glycol, tetraethylene glycol, dipropylene glycol, tripropylene glycol, polyethylene, polypropylene or polybutylene glycols having a maximum number-average molecular weight of 2000 g/mol, preferably 1000 g/mol and particularly preferably 500 g/mol. Reaction products of the above-mentioned diols with ε-caprolactone can likewise be used as diols. Suitable trihydric and higher hydric alcohols are, for example, glycerol, trimethylolpropane, pentaerythritol, dipentaerythritol and sorbitol as well as mixtures of these compounds. Preference is given to hexanediol, neopentyl glycol, 1,4-cyclohexanedimethanol and trimethylolpropane as well as reaction products of these diols with ε-caprolactone.

It is also possible to use as component A3) hydroxycarboxylic acids having from 2 to 10 carbon atoms, lactones of such acids, amino alcohols having a molecular weight in the range from 61 to 300 and/or aminocarboxylic acids having a molecular weight in the range from 75 to 400, such as, for example, dimethylolpropionic acid, lactic acid, malic acid, tartaric acid, ε-caprolactone, aminoethanol, aminopropanol, diethanolamine, aminoacetic acid or aminohexanoic acid, as well as mixtures of these compounds. ε-Caprolactone is preferred.

Suitable components A4) are, for example, tetrahydrophthalic acid, tetrahydrophthalic anhydride, maleic acid, maleic anhydride, fumaric acid, crotonic acid, itaconic acid, unsaturated fatty acids, such as, for example, soybean oil fatty acid, tall oil fatty acid, glycerol monoallyl ether, trimethylolpropane monoallyl ether, 1,4-butenediol or addition products of allylglycidyl ether or glycidyl methacrylate with a carboxyl-group-containing polyester, as well as mixtures of these compounds. Preference is given to maleic anhydride, tetrahydrophthalic acid, tetrahydrophthalic anhydride and 1,4-butenediol. Suitable components A5) are monoalcohols, such as, for example, ethanol, 1- and 2-propanol, 1- and 2-butanol, 1-hexanol, 2-ethylhexanol, cyclohexanol and benzyl alcohol, and/or monocarboxylic acids, such as, for example, benzoic acid, cyclohexanecarboxylic acid, 2-ethylhexanoic acid, caproic acid, caprylic acid, capric acid, lauric acid or natural and synthetic fatty acids. Preference is given to 2-ethylhexanol, benzyl alcohol, benzoic acid, cyclohexanecarboxylic acid or 2-ethylhexanoic acid.

The polyester A) is composed of from 40 to 65 wt. %, preferably from 45 to 60 wt. % and particularly preferably from 49 to 58 wt. %, component A1), from 33 to 60 wt. %, preferably from 33 to 57 wt. % and particularly preferably from 40 to 55 wt. %, component A2), from 0 to 20 wt. %, preferably from 0 to 15 wt. % and particularly preferably from 0 to 12 wt. %, component A3), from 0 to 6 wt. %, preferably from 0.5 to 4 wt. % and particularly preferably from 0.7 to 3.5 wt. %, component A4) and from 0 to 10 wt. %, preferably from 0 to 8 wt. % and particularly preferably from 0 to 5 wt. %, component A5).

The polyacrylate component B) is prepared from the monomer mixture B1), B2) and B3) by free-radical-initiated copolymerisation in organic solution. Component B4) is an optional constituent of the monomer mixture,

Acrylates and methacrylates (referred to hereinbelow as (meth)acrylates) having from 1 to 18 carbon atoms in the alcohol part of the ester group are used as monomers of component B1). This alcohol part can be linear, branched or cycloaliphatic.

Examples of suitable monomers of component B1) are methyl, ethyl, n-propyl, isopropyl, n-butyl, isobutyl, tert-butyl, the isomeric pentyl, hexyl, 2-ethylhexyl, octyl, dodecyl, hexadecyl, octadecyl or cyclohexyl, trimethylcyclohexyl and isobornyl (meth)acrylates. Acetoacetoxyethyl methacrylate, acrylamide, diacetoneacrylamide, acrylonitrile, styrene, vinyl ether, methacrylonitrile, vinyl acetates, optionally substituted styrenes or vinyltoluenes can also be used as B1). Preference is given to methyl, isopropyl, n-butyl, isobutyl, tert-butyl, 2-ethylhexyl, cyclohexyl or isobornyl (meth)acrylates as well as styrene.

Any desired mixtures of the above-mentioned compounds B1) are preferably used. Preference is given to a mixture of at least one monomer B1) whose homopolymer has a glass transition temperature ≧40° C. and at least one further monomer B1) whose homopolymer has a glass transition temperature <40° C.

Suitable as component B2) are ethylenically unsaturated, hydroxyl-group-containing monomers, such as, for example, the hydroxyalkyl esters of unsaturated carboxylic acids, preferably hydroxyalkyl (meth)acrylates having from 2 to 12 carbon atoms, preferably from 2 to 8 carbon atoms, in the hydroxyalkyl radical. Preferred compounds are 2-hydroxyethyl (meth)acrylate, the isomeric hydroxypropyl (meth)acrylates, 2-, 3- and 4-hydroxybutyl (meth)acrylates, the isomeric hydroxyhexyl (meth)acrylates as well as 1,4-cyclohexanedimethanol monomethacrylate.

Also suitable are polymerisable hydroxy-functional monomers having a number-average molecular weight ≦3000 g/mol, preferably ≦700 g/mol, which have been modified or chain-lengthened with alkylene oxides. There are used as alkylene oxides preferably ethylene, propylene or butylene oxide, individually or in mixtures. Examples which may be mentioned include Bisomer® PEA3 (polyethylene glycol monoacrylate; 3 ethylene oxide units, Degussa AG, DE), Bisomer® PEM 6 LD polyethylene glycol monomethacrylate; 6 ethylene oxide units, Degussa AG, DE), Bisomer® PPM 63 E (polyethylene glycol monomethacrylates; 6 propylene oxide units and 3 terminal ethylene oxide units, Degussa AG, DE) or Bisomer® PEM 63 P (polyethylene glycol monomethacrylates; 6 ethylene oxide units and 3 terminal propylene oxide units, Degussa AG, DE).

Furthermore, the addition of polymerisable alkoxypolyethylene glycol (meth)acrylates having number-average molecular weights (Mn) of from 430 to 2500 g/mol and having a non-ionically hydrophilising action is suitable. Examples which may be mentioned here include Bisomer® MPEG 350 MA (Mn=430 g/mol), 550 MA (Mn=628 g/mol), S 7 W (Mn=818 g/mol), S 10 W (Mn=1080 g/mol) and S 20 W (Mn=2080 g/mol) from Degussa AG, DE.

Suitable acid-group-containing compounds B3) are ionically or potentially ionically hydrophilising compounds which have at least one group capable of free-radical polymerisation and also at least one functionality, such as —COOY, —SO₃Y, —PO(OY)₂ (Y for example=H, NH₄⁺, metal cation), —NR₂ or —NR₃⁺ (R═H, alkyl, aryl, radicals R in a molecule can be identical or different from one another), which enter into a pH-dependent dissociation equilibrium on interaction with aqueous media and in that manner can be negatively, positively or neutrally charged.

Preferred components B3) are olefinically unsaturated monomers having carboxylic acid or carboxylic anhydride groups, such as, for example, acrylic acid, methacrylic acid, β-carboxyethyl acrylate, crotonic acid, fumaric acid, maleic anhydride, itaconic acid or monoalkyl esters of dibasic acids or anhydrides, such as, for example, maleic acid monoalkyl esters; acrylic acid and/or methacrylic acid are particularly preferred.

Also suitable as compounds of component B3) are unsaturated, free-radically polymerisable compounds having phosphate, or phosphonate, or sulfonic acid, or sulfonate, groups, as described, for example, in WO-A 00/39181 (p. 8, line 13—p. 9, line 19). Within the group of the components containing phosphate, or phosphonate, or sulfonic acid, or sulfonate, groups, 2-acrylamido-2-methylpropanesulfonic acid is a preferred component.

The hydrophilisation of the copolymers according to the invention is preferably effected only by ionic and/or potentially ionic groups, which are introduced into the copolymer via the compounds of component B3). The hydrophilisation is particularly preferably effected by anionic and/or potentially anionic groups.

Further monomers of component B4) capable of free-radical polymerisation, other than B1) to B3), are, for example, di- or higher-functional (meth)acrylate monomers and/or vinyl monomers, such as, for example, ethanediol di(meth)acrylate, hexanediol di(meth)acrylate, 1,4-, 1,3-butanediol dimethacrylate, di-, tri- and oligo-ethylene glycol dimethacrylates, polypropylene glycol dimethacrylates, polytetramethylene glycol dimethacrylates or divinylbenzene. However, these are only optionally used as structural units of the polyacrylate component B).

The ratios of the structural components B1) to B4) are generally so chosen that the OH number of component B) is from 10 to 180 mg KOH/g, preferably from 40 to 160 mg KOH/g and particularly preferably from 60 to 150 mg KOH/g solid, and the acid number is from 10 to 100 mg KOH/g solid, preferably from 15 to 80 mg KOH/g solid, particularly preferably from 20 to 60 mg KOH/g solid.

In general, the process for the preparation of the copolymer dispersions according to the invention is carried out according to processes known to the person skilled in the art. To this end, the polyester component A), optionally dissolved in an organic solvent, is typically placed in a reaction vessel, the monomers B1) to B4) are metered in in, and polymerisation is carried out using a free-radical initiator.

It is likewise possible to place only the polyester component A) in the reaction vessel and to add the organic solvent during the polymerisation. When particularly efficient stirring units are used, it is also possible for the addition of the solvent to take place only after polymerisation of the monomers B1) to B4). In addition, it is also possible to place only some of the polyester A) in the reaction vessel and to add the remainder during the polymerisation.

The copolymerisation is carried out at from 40 to 200° C., preferably at from 60 to 180° C., particularly preferably at from 80 to 160° C.

Organic solvents can in particular also serve to dilute the initiators. Suitable solvents for dissolving or diluting the polyester as well as the initiator are any components known in lacquer technology, such as, for example, alcohols, ethers, alcohols containing ether groups, ketones, N-alkylated lactams or non-polar hydrocarbons, or mixtures of these solvents. These include n-propanol, n-butanol, ethylene glycol n-butyl ether, diethylene glycol n-butyl ether, diethylene glycol methyl ether, diethylene glycol ethyl ether, propylene glycol, propylene glycol methyl ether, propylene glycol ethyl ether, propylene glycol n-propyl ether, di- and tri-propylene glycol methyl ether, dipropylene glycol n-propyl ether, di- and tri-propylene glycol n-butyl ether, propylene glycol n-butyl ether, propylene glycol tert-butyl ether, di-, tri-, tetra- and penta-propylene glycol dimethyl ether, N-ethylpyrrolidone, acetone, 2-butanone or solvent naphtha. Mixtures of the mentioned solvents are likewise suitable. Preference is given to the use of those solvents which are miscible with water in any ratio, which include n-butanol, ethylene glycol n-butyl ether, diethylene glycol n-butyl ether, diethylene glycol methyl ether, diethylene glycol ethyl ether, propylene glycol, propylene glycol methyl ether, propylene glycol ethyl ether, propylene glycol n-propyl ether, di- and tri-propylene glycol methyl ether, N-ethylpyrrolidone, acetone or 2-butanone. Particular preference is given to the use of the water-soluble solvents ethylene glycol n-butyl ether, diethylene glycol n-butyl ether, diethylene glycol methyl ether, diethylene glycol ethyl ether, propylene glycol methyl ether, propylene glycol ethyl ether, propylene glycol n-propyl ether and di- and tri-propylene glycol methyl ether.

The organic solvents are used in amounts such that their content in the copolymer dispersion according to the invention is from 0 to 15 wt. %, preferably from 2 to 12 wt. %.

Suitable initiators for the polymerisation reaction are organic peroxides, such as di-tert-butyl peroxide, dicumyl peroxide, 2,5-dimethyl-2,5-di(tert-butylperoxy)hexane, tert-butyl peroxybenzoate, dibenzoyl peroxide, tert-butyl perisobutyrate or tert-butyl peroxy-2-ethylhexanoate, or azo compounds, such as azodiisobutyric acid nitrite (AIBN). The amounts of initiator used depend on the desired molecular weight. For reasons of process safety and easier handling, peroxide initiators can also be used in the form of a solution in suitable organic solvents of the type mentioned above. Preferred initiators are peroxide initiators.

The invention also provides a process for the preparation of the copolymer dispersions according to the invention, characterised in that the polyester A) is placed in a water-miscible solvent and then, in a step (I), a hydroxy-functional monomer mixture (B′) of components B1), B2) and optionally B4) is added to the polyester A) and this monomer mixture (B′) has an OH number of from 12 to 350 mg KOH/g solid and an acid number of from 0 to 50 mg KOH/g solid, and in a second step (II) a further monomer mixture (B″) of monomers of components B1), B2), B3) and optionally B4) is added and this monomer mixture (B″) has an OH number of from 10 to 350 mg KOH/g solid and an acid number of from 50 to 300 mg KOH/g solid, and then the copolymer is dispersed in water, wherein the monomer amounts in steps (I) and (II) are to be so chosen that the ratio of the monomer mixture (B′) to the monomer mixture (B″) is from 10:1 to 1:2.

In a preferred form of the process for the preparation of the copolymer contained in the aqueous copolymer dispersions according to the invention, the polyester A) is placed in from 70 to 90 wt. % of the solvent, and then a two-stage addition and polymerisation of unsaturated monomers B1) to B4) takes place, metering of the initiator, which is present in solution in from 10 to 30 wt. % of the remaining solvent, taking place in parallel or over a prolonged period.

The preparation of the copolymer contained in the aqueous copolymer dispersions according to the invention is preferably carried out in two steps (I) and (II). In the first step (I), a hydroxy-functional monomer mixture (B′) of components B 1), B2) and optionally B4) is added to the polyester component A), which has already been placed in the reaction vessel, and this hydroxy-functional monomer mixture (B′) has an OH number of from 12 to 350 mg KOH/g solid, preferably from 20 to 200 mg KOH/g solid, and an acid number of from 0 to 50 mg KOH/g solid, preferably from 0 to 30 mg KOH/g solid.

From 50 to 90 wt. %, preferably from 60 to 80 wt. %, of component B′1), from 2 to 50 wt. %, preferably from 5 to 35 wt. %, of component B′2) and from 0 to 50 wt. %, preferably from 3 to 30 wt. %, of component B′4) are preferably mixed together, the wt. % being based on the monomer mixture B′) and adding up to 100 wt. %.

In a subsequent step (II), a further monomer mixture (B″) of monomers of components B1), B2), B3) and optionally B4) is added to the reaction mixture obtained from step (I), and this monomer mixture (B″) has an OH number of from 10 to 350 mg KOH/g solid, preferably from 18 to 200 mg KOH/g solid, and an acid number of from 50 to 300 mg KOH/g solid, preferably from 70 to 200 mg KOH/g solid. After the preparation, the copolymer should have an OH number that is smaller than that of the polyester component A) and greater than 10 mg KOH/g.

From 45 to 85 wt. %, preferably from 55 to 75 wt. %, of component B″1), from 1 to 50 wt. %, preferably from 5 to 35 wt. %, of component B″2), from 3 to 30 wt. %, preferably from 8 to 22 wt. %, of component B″3) and from 0 to 50 wt. %, preferably from 3 to 30 wt. %, of component B″4) are preferably mixed together, the wt. % being based on the monomer mixture B″) and adding up to 100 wt. %.

In the process according to the invention, the monomer amounts in steps (I) and (II) are to be so chosen that the ratio of the monomer mixture (B′) to the monomer mixture (B″) is from 10:1 to 1:2, preferably from 6:1 to 2:1.

Instead of a multi-stage polymerisation process, it is likewise possible to carry out the process continuously (gradient polymerisation), i.e. a monomer mixture whose composition changes over time is added, the hydrophilic monomer components according to component A3) and optionally A4) preferably being higher towards the end of the addition than at the beginning.

The copolymers contained in the aqueous copolymer dispersions according to the invention have number-average molecular weights Mn of from 500 to 30,000 g/mol, preferably from 1000 to 15,000 g/mol, particularly preferably from 1500 to 10,000 g/mol, and weight-average molecular weights M_{w} of from 30,000 to 500,000 g/mol, preferably from 50,000 to 250,000 g/mol, particularly preferably from 65,000 to 150,000 g/mol.

The preparation of the copolymer dispersion according to the invention is then carried out as follows: before, during or after the dispersion of the hydroxy-functional copolymers in water, at least some of the acid groups present are converted into their salt form by addition of suitable neutralising agents. The acid groups of the copolymer are preferably neutralised before the dispersion.

Suitable neutralising agents are organic amine compounds or water-soluble inorganic bases, such as, for example, soluble metal hydroxides, carbonates or hydrogen carbonates.

Examples of suitable amines are N-methylmorpholine, N-ethylmorpholine, triethylamine, ethyldiisopropylamine, N,N-dimethylethanolamine, N,N-dimethylisopropanolamine, N-methyldiethanolamine, diethylethanolamine, triethanolamine, butanolamine, morpholine, 2-aminomethyl-2-methyl-propanol or isophoronediamine. In mixtures, ammonia can also be used proportionately. Preference is given to triethanolamine, N,N-dimethylethanolamine or ethyldiisopropylamine.

The neutralising agents are added in amounts such that an overall theoretical degree of neutralisation [of the acid groups] of from 40 to 150%, preferably from 60 to 120%, is present. The degree of neutralisation is understood as being the molar ratio of added basic groups of the neutralising component to acid functions of the copolymer.

The pH value [20° C.] of the copolymer dispersion according to the invention is from 6 to 10, preferably from 6.5 to 9.

The aqueous copolymer dispersions according to the invention have a solids content of from 25 to 70 wt. %, preferably from 35 to 60 wt. %, particularly preferably from 40 to 55 wt. %.

The copolymer dispersions according to the invention can be processed to aqueous coating compositions. By combination with crosslinkers it is possible, depending on the reactivity or optionally blocking of the crosslinkers, to prepare both one-component (1K) lacquers and two-component (2K) lacquers. Suitable crosslinkers reactive towards OH groups are, for example, polyisocyanate crosslinkers, amide- and amine-formaldehyde resins, phenolic resins, aldehyde and ketone resins, such as, for example, phenol-formaldehyde resins, resols, furan resins, urea resins, carbamic acid ester resins, triazine resins, melamine resins, benzoguanamine resins, cyanamide resins or aniline resins.

The invention also provides aqueous coating compositions comprising the aqueous copolymer dispersions according to the invention and at least one crosslinker reactive towards OH groups.

The present invention also provides two-component (2K) lacquers comprising the copolymer dispersions according to the invention and at least one crosslinker selected from the group of the polyisocyanates.

As crosslinkers for two-component lacquers there are preferably used polyisocyanates which typically contain 2 or more NCO groups per molecule and are based, for example, on isophorone diisocyanate, hexamethylene diisocyanate, 1,4-diisocyanatocyclohexane, bis-(4-isocyanatocyclohexane)-methane, 1,3-diisocyanatobenzene, triisocyanatononane or the isomers 2,4- and 2,6-TDI and which can further contain urethane, isocyanurate and/or biuret groups.

Hydrophilically modified polyisocyanates or hydrophobic polyisocyanates can be used as crosslinkers, because the copolymers contained in the copolymer dispersions according to the invention are generally sufficiently hydrophilic.

The polyisocyanates used as crosslinkers generally have a viscosity at 23° C. of from 10 to 5000 mPa s. The polyisocyanates are preferably used in admixture with small amounts of inert solvents in order to achieve a reduction in the viscosity and accordingly improved incorporation of the polyisocyanate into the dispersion of the copolymer (P).

Before, during or after the preparation of the aqueous copolymer dispersion according to the invention, conventional auxiliary substances and additives of lacquer technology can be added, such as, for example, antifoams, thickening agents, pigments, dispersing aids, catalysts, anti-skinning agents, anti-settling agents or emulsifiers.

The aqueous coating compositions containing the aqueous copolymer dispersions according to the invention are suitable for all fields of use in which aqueous painting and coating systems having high demands in respect of the resistance and the appearance of the films are used, for example for the coating of mineral building material surfaces, lacquering and sealing of wood and wood materials, coating of metal surfaces (metal coating), coating and lacquering of asphalt- or bitumen-containing coverings, lacquering and sealing of various plastics surfaces (plastics coating), and high-gloss lacquers.

The aqueous coating compositions containing the aqueous copolymer dispersions according to the invention are used in the production of primers, fillers, pigmented or transparent finishing lacquers, clear lacquers and high-gloss lacquers as well as single-layer lacquers, which can be employed in individual and series lacquering, for example in the field of industrial lacquering, automotive initial and repair lacquering. Preference is given to their use as a multi-layer structure, wherein the uppermost layer is a finishing lacquer or clear lacquer layer which contains the aqueous copolymer dispersions according to the invention.

At layer thicknesses of from 90 μm to 180 μm, the coatings produced from the aqueous coating compositions containing the aqueous copolymer dispersions according to the invention have a very good film appearance, a high level of resistance to solvents and chemicals, good resistance to weathering and high hardness.

The production of the coatings containing the aqueous copolymer dispersions according to the invention can be carried out by various spraying processes, such as, for example, compressed-air, airless or electrostatic spraying processes, using single- or optionally two-component spraying installations. The lacquers and coating compositions containing the aqueous, hydroxy-functional polyester-polyacrylate graft polymer dispersions can, however, also be applied by other methods, for example by spreading, roller application or knife application.

### EXAMPLES

Unless indicated otherwise, all percentages relate to wt. %.

Viscosity measurements were carried out according to DIN 53019 with a shear gradient of 40 s⁻¹ using a Physica Viscolab® LC3 ISO cone-plate viscometer from Physica, Stuttgart, Germany.

The mean particle size was determined by means of laser correlation spectroscopy (HPPS, Malvern Instruments, Herrenberg, Germany).

GPC: Tetrahydrofuran at a flow rate of 0.6 ml/min was used as eluant. As stationary phase there were used four columns of the Nucleogel® brand, GPC 106-10 300×7.8 mm, GPC 104-10 300×7.8 mm, GPC 500-10 300×7.8 mm and GPC 100-10 300×7.8 mm from Macherey-Nagel, Düren, Germany.

The OH numbers indicated were calculated starting from the OH-carrying components used.

Acid numbers: method of determination, DIN ISO 3682

### Compounds Used:

| | |
|---|---|
| Peroxan ® Po | tert-butylperoxy 2-ethylhexanoate, PERGAN |
| 49 B: | GmbH, Bocholt, Germany |
| Bayhydur ® VP | polyisocyanate based on hexamethylene |
| LS 2319: | diisocyanate and rendered hydrophilic with |
| | polyethylene groups, NCO content of 18 wt. %, from |
| | Bayer MaterialScience AG, Leverkusen, Germany |
| Dowanol ®: | solvent from Dow Chemical, Ahlen, Germany |

### Polyester Precursor

### Example A

6603 g of trimethylolpropane are weighed at 20° C. into a 20-litre reaction vessel equipped with a stirrer, a cooling and heating device and a water separator, and melted at 100° C. 126 g of maleic anhydride, 4361 g of hexahydrophthalic anhydride, 2114 g of phthalic anhydride and 2-ethylhexanoic acid are then added, with stirring, and the mixture is heated to 150° C. in the course of one hour while a stream of nitrogen is passed through. Thereafter, the temperature is adjusted to 200° C. in the course of 6 hours and condensation is carried out in the stream of nitrogen until the acid number falls below 8 mg KOH/g substance.

Acid number: 7.0 mg KOH/g

OH number: 216 mg KOH/g

### Example B

7180 g of trimethylolpropane are weighed at 20° C. into a 20-litre reaction vessel equipped with a stirrer, a cooling and heating device and a water separator, and melted at 100° C. 137 g of maleic anhydride, 4742 g of hexahydrophthalic anhydride and 2299 g of phthalic anhydride are then added, with stirring, and the mixture is heated to 150° C. in the course of one hour while a stream of nitrogen is passed through. Thereafter, the temperature is adjusted to 200° C. in the course of 6 hours and condensation is carried out in the stream of nitrogen until the acid number falls below 8 mg KOH/g substance.

Acid number: 7.7 mg KOH/g

OH number: 269 mg KOH/g

### Example C

7130 g of trimethylolpropane are weighed at 20° C. into a 20-litre reaction vessel equipped with a stirrer, a cooling and heating device and a water separator, and melted at 100° C. 136 g of maleic anhydride and 7087 g of hexahydrophthalic anhydride are then added, with stirring, and the mixture is heated to 150° C. in the course of one hour while a stream of nitrogen is passed through. Thereafter, the temperature is adjusted to 200° C. in the course of 6 hours and condensation is carried out in the stream of nitrogen until the acid number falls below 8 mg KOH/g substance.

Acid number: 7.3 mg KOH/g

OH number: 266 mg KOH/g

### Example D

### Polyester Precursor

1659 g of trimethylolpropane, 5146 g of neopentyl glycol are weighed at 20° C. into a 20-litre reaction vessel equipped with a stirrer, a cooling and heating device and a water separator, and melted at 100° C. 122 g of maleic anhydride, 2059 g of isophthalic acid and 5666 g of phthalic anhydride are then added, with stirring, and the mixture is heated to 150° C. in the course of one hour while a stream of nitrogen is passed through. Thereafter, the temperature is adjusted to 200° C. in the course of 6 hours and condensation is carried out in the stream of nitrogen until the acid number falls below 8 mg KOH/g substance.

Acid number: 5.9 mg KOH/g

OH number: 122 mg KOH/g

### Polyester Polyacrylates

### Example 1

### According to the Invention

750 g of polyester precursor according to Example B and 258.0 g of Dowanol® PnB are placed in a 4-litre reaction vessel equipped with a stirrer and a cooling and heating device, and heated to 120° C. A solution of 30.6 g of Peroxan® PoB in 30.6 g of Dowanol® PnB is uniformly added dropwise at that temperature in the course of 240 minutes. Five minutes after the beginning of the metering of the initiator solution, a monomer mixture of 119 g of methyl methacrylate, 145 g of hydroxyethyl methacrylate and 218 g of butyl acrylate is metered in the course of 2 hours. Immediately thereafter, a mixture of 59.5 g of methyl methacrylate, 72.5 g of hydroxyethyl methacrylate, 109 g of butyl acrylate and 27 g of acrylic acid is metered in the course of 60 minutes. Stirring is then carried out for 1 hour at 120° C., followed by cooling to 100° C. and addition of 40.3 g of dimethylethanolamine. After 20 minutes' homogenisation, dispersion with 1584 g of water is carried out at 90° C. in the course of 10 minutes. When the mixing temperature of 78° C. is reached, homogenisation is continued for a further 1.5 hours before the dispersion is filtered and cooled to room temperature.

| | |
|---|---|
| OH content (solid): | 5.85% (calculated theoretically) |
| acid number (solid): | 17.6 mg KOH/g |
| solids content: | 43.8% |
| viscosity: | 5280 mPas/23° C. |
| pH value (10% in water): | 8.6 |
| mean particle size: | 114 nm |
| M_{w}: | 85,500 g/mol |

### Example 2

### According to the Invention

750 g of polyester precursor according to Example C and 258.0 g of butyl diglycol are placed in a 4-litre reaction vessel equipped with a stirrer and a cooling and heating device, and heated to 120° C. A solution of 30.6 g of Peroxan® PoB in 30.6 g of butyl diglycol is uniformly added dropwise at that temperature in the course of 240 minutes. Five minutes after the beginning of the metering of the initiator solution, a monomer mixture of 119 g of methyl methacrylate, 145 g of hydroxyethyl methacrylate and 218 g of butyl acrylate is metered in the course of 2 hours. Immediately thereafter, a mixture of 59.5 g of methyl methacrylate, 72.5 g of hydroxyethyl methacrylate, 109 g of butyl acrylate and 27 g of acrylic acid is metered in in the course of 60 minutes. Stirring is then carried out for 1 hour at 120° C., followed by cooling to 100° C. and addition of 40.3 g of dimethylethanolamine. After 20 minutes' homogenisation, dispersion with 1584 g of water is carried out at 90° C. in the course of 10 minutes. When the mixing temperature of 78° C. is reached, homogenisation is continued for a further 1.5 hours before the dispersion is filtered and cooled to room temperature.

| | |
|---|---|
| OH content (solid): | 5.85% (calculated theoretically) |
| acid number (solid): | 17.6 mg KOH/g |
| solids content: | 43.8% |
| viscosity: | 5280 mPas/23° C. |
| pH value (10% in water): | 8.6 |
| mean particle size: | 88 nm |
| M_{w}: | 67,400 g/mol |

### Example 3

### According to the Invention

750 g of polyester precursor according to Example B and 258.0 g of Dowanol® PM are placed in a 4-litre reaction vessel equipped with a stirrer and a cooling and heating device, and heated to 120° C. A solution of 30.6 g of Peroxan® PoB in 30.6 g of Dowanol® PM is uniformly added dropwise at that temperature in the course of 240 minutes. Five minutes after the beginning of the metering of the initiator solution, a monomer mixture of 65 g of styrene, 60 g of methyl methacrylate, 145 g of hydroxyethyl methacrylate and 218 g of 2-ethylhexyl acrylate is metered in in the course of 2 hours. Immediately thereafter, a mixture of 31.5 g of styrene, 28 g of methyl methacrylate, 72.5 g of hydroxyethyl methacrylate, 109 g of 2-ethylhexyl acrylate and 27 g of acrylic acid is metered in in the course of 60 minutes. Stirring is then carried out for 1 hour at 120° C., followed by cooling to 100° C. and addition of 40.3 g of dimethylethanolamine. After 20 minutes' homogenisation, dispersion with 1584 g of water is carried out at 90° C. in the course of 10 minutes. When the mixing temperature of 78° C. is reached, homogenisation is continued for a further 1.5 hours before the dispersion is filtered and cooled to room temperature.

| | |
|---|---|
| OH content (solid): | 5.85% (calculated theoretically) |
| acid number (solid): | 16.6 mg KOH/g |
| solids content: | 45.8% |
| viscosity: | 4280 mPas/23° C. |
| pH value (10% in water): | 8.7 |
| mean particle size: | 120 nm |
| M_{w}: | 69,800 g/mol |

### Example 4

### According to the Invention

750 g of polyester precursor according to Example A and 258.0 g of butyl diglycol are placed in a 4-litre reaction vessel equipped with a stirrer and a cooling and heating device, and heated to 120° C. A solution of 30.6 g of Peroxan® PoB in 30.6 g of butyl diglycol is uniformly added dropwise at that temperature in the course of 240 minutes. Five minutes after the beginning of the metering of the initiator solution, a monomer mixture of 35 g of styrene, 90 g of methyl methacrylate, 145 g of hydroxyethyl methacrylate and 218 g of 2-ethylhexyl acrylate is metered in in the course of 2 hours. Immediately thereafter, a mixture of 20 g of styrene, 39.5 g of methyl methacrylate, 72.5 g of hydroxyethyl methacrylate, 109 g of 2-ethylhexyl acrylate and 27 g of acrylic acid is metered in in the course of 60 minutes. Stirring is then carried out for 1 hour at 120° C., followed by cooling to 100° C. and addition of 40.3 g of dimethylethanolamine. After 20 minutes' homogenisation, dispersion with 1584 g of water is carried out at 90° C. in the course of 10 minutes. When the mixing temperature of 78° C. is reached, homogenisation is continued for a further 1.5 hours before the dispersion is filtered and cooled to room temperature.

OH content (solid): 5.85% (calculated theoretically)

acid number (solid): 17.0 mg KOH/g

solids content: 45.8%

viscosity: 5220 mPas/23° C.

pH value (10% in water): 8.5

mean particle size: 150 nm

Mw: 430,000 g/mol

### Example 5

### According to the Invention

750 g of polyester precursor according to Example B and 172.9 g of butyl diglycol are placed in a 4-litre reaction vessel equipped with a stirrer and a cooling and heating device, and heated to 120° C. A solution of 30.6 g of Peroxan PoB in 29.1 g of Isopar® M is uniformly added dropwise at that temperature in the course of 240 minutes. Five minutes after the beginning of the metering of the initiator solution, a monomer mixture of 119 g of methyl methacrylate, 145 g of hydroxyethyl methacrylate and 218 g of butyl acrylate and, in parallel therewith, 86.6 g of Isopar® M is metered in in the course of 2 hours. Immediately thereafter, a mixture of 59.5 g of methyl methacrylate, 72.5 g of hydroxyethyl methacrylate, 109 g of 2-ethylhexyl acrylate and 27 g of acrylic acid is metered in in the course of 60 minutes. Stirring is then carried out for 1 hour at 120° C., followed by cooling to 100° C. and addition of 40.3 g of dimethylethanolamine. After 20 minutes' homogenisation, dispersion with 1584 g of water is carried out at 90° C. in the course of 10 minutes. When the mixing temperature of 78° C. is reached, homogenisation is continued for a further 1.5 hours before the dispersion is filtered and cooled to room temperature.

| | |
|---|---|
| OH content (solid): | 5.85% (calculated theoretically) |
| acid number (solid): | 18.1 mg KOH/g |
| solids content: | 43.8% |
| viscosity: | 5550 mPas/23° C. |
| pH value (10% in water): | 8.5 |
| mean particle size: | 126 nm |
| M_{w}: | 87,100 g/mol |

### Comparison Example 6

750 g of polyester precursor according to Example D and 223.7 g of butyl diglycol are placed in a 4-litre reaction vessel equipped with a stirrer and a cooling and heating device, and heated to 140° C. A solution of 11.3 g of Peroxan® DB in 22.5 g of butyl diglycol is added dropwise at that temperature in the course of 125 minutes. Five minutes after the beginning of the metering of the initiator solution, a monomer mixture of 185 g of methyl methacrylate, 150 g of hydroxyethyl methacrylate, 50 g of butyl acrylate, 50 g of isobutyl methacrylate and 35 g of styrene is metered in in the course of 2 hours. Immediately thereafter, a mixture of 92.5 g of methyl methacrylate, 75 g of hydroxyethyl methacrylate, 25 g of butyl acrylate, 25 g of isobutyl methacrylate, 17.5 g of styrene and 45 g of acrylic acid is metered in in the course of 60 minutes; in parallel therewith, a solution of 11.3 g of di-tert-butyl peroxide in 23.5 g of butyl diglycol is metered in in uniformly over a period of 2 hours. Stirring is then carried out for 1 hour at 140° C., followed by cooling to 100° C. and addition of 45 g of dimethylethanolamine. After 20 minutes' homogenisation, dispersion with 1725 g of water is carried out at 90° C. in the course of 10 minutes. When the mixing temperature of 78° C. is reached, homogenisation is continued for a further 1.5 hours before the dispersion is then filtered and cooled to room temperature.

| | |
|---|---|
| OH content (solid): | 3.75% (calculated theoretically) |
| acid number (solid): | 25.7 mg KOH/g |
| solids content: | 45.3% |
| viscosity: | 2300 mPas/23° C. |
| pH value (10% in water): | 7.6 |
| degree of neutralisation: | 75% |
| mean particle size: | 132 nm |
| M_{w}: | 13,400 g/mol |

### Lacquer Preparation and Application

### Finishing Lacquer:

The binders mentioned in the examples are formulated with additives (see Tab. 1). The binders mentioned in Examples 1 to 5 are referred to as polyol in Tab. 1. The polyol is placed in a vessel, and components (2) to (5) are added in succession at 2000 rpm. Each of the components is added in the course of two minutes. Finally, component (6) is added at the same stirring speed in the course of 10 minutes. Thereafter, the batch is ground for 60 minutes in a bead mill and then deaerated for one day at ambient pressure.

Before application, the curing agent component is prepared by mixing 4.1 g of methoxybutyl acetate with 16.2 g of the polyisocyanate Bayhydur® LS 2319. At a stirring speed of 2000 rpm, the curing agent component is fed in portions to the formulated polyol mixture in the course of 2 minutes. Then the viscosity is diluted by addition of water so that a run-out time of about 25 seconds in a DIN 4 beaker is obtained. In the case of an airless application, the viscosity was adjusted to 45 seconds in a DIN 4 beaker.

TABLE 1
Components for a finishing lacquer

| | | | Parts by |
|---|---|---|---|
| Components | | Manufacturer/Function | weight |
| (1) | Polyol (Ex. 2) | | 30.1 |
| (2) | Surfynol ® 104 BC (50.0% | Air Products NL | 0.9 |
| | in butyl glycol | flow, substrate wetting, | |
| | | defoaming | |
| (3) | Borchigel ® PW 25 | Borchers GmbH, Langenfeld | 0.1 |
| | (25.0% in propylene | PUR thickener | |
| | glycol/water 1:1) | | |
| (4) | Baysilone ® VP AI 3468 | Slip additive | 0.7 |
| | (10.0% in butyl glycol) | Borchers GmbH, Langenfeld | |
| (5) | Borchigen ® SN 95 | Dispersing additive | 5.7 |
| | (25.0% in water) | Borchers GmbH, Langenfeld | |
| (6) | Tronox ® R-KB 4 | Kerr-McGee | 23.6 |
| | | Pigments/Krefeld | |
| | | Pigment | |

The lacquer is applied by means of a spray gun (Sata RP-digital; nozzle: 1.4 mm) at a pressure of 1.4 bar. The applied lacquer is then exposed to air for 30 minutes at room temperature before further drying takes place for a further 30 minutes at 60° C.

Airless application: 180 bar; spray viscosity: DIN 4=45 s

Clear lacquer:

The binders mentioned in the Examples are formulated with additives (see Tab. 2). The polyol is placed in a vessel, and components (2) to (4) are added in succession at 2000 rpm. Each of the components is added in the course of two minutes. The lacquer is then deaerated for one day at ambient pressure.

TABLE 2
Components for a clear lacquer

| Component | | Parts by weight |
|---|---|---|
| (1) | Polyol (Ex. 1-6) | 41.9 |
| (2) | Surfynol 104 BC (50.0% in butyl glycol) | 1.2 |
| (3) | Borchigel PW 25 (25.0% in propylene | 0.2 |
| | glycol/water 1:1) | |
| (4) | Baysilone VP AI 3468 (10.0% in butyl glycol) | 1.0 |

Before application, the curing agent component is prepared by mixing 5.6 g of methoxybutyl acetate with 22.6 g of the polyisocyanate Bayhydur® LS 2319. At a stirring speed of 2000 rpm, the curing agent component is fed in portions to the formulated polyol mixture in the course of 2 minutes. Then the viscosity is diluted by addition of water so that a run-out time of about 25 seconds in a DIN 4 beaker is obtained.

The lacquer is applied by means of a spray gun (Sata RP-digital; nozzle: 1.4 mm) at a pressure of 1.4 bar. The applied lacquer is then exposed to air for 30 minutes at room temperature before further drying takes place for a further 30 minutes at 60° C.

TABLE 3
Application results in spray tests at 1.4 bar

| | Clear lacquer | | | | | | Finishing |
|---|---|---|---|---|---|---|---|
| Lacquer from | | | | | | Comp. | lacquer |
| polyol | Ex. 1 | Ex. 2 | Ex. 3 | Ex. 4 | Ex. 5 | Ex. 6 | Ex. 2 |
| Max. blister- | 100 | 140 | 105 | 110 | 145 | 85 | 130 |
| free layer | | | | | | | |
| thickness | | | | | | | |

TABLE 4
Application results in spray tests at 180 bar

| | Clear lacquer | Finishing lacquer |
|---|---|---|
| Lacquer from polyol | Ex. 1 | Ex. 2 |
| Max. blister-free layer | 90 | 90 |
| thickness | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Aqueous copolymer dispersions comprising
a polyester component A) that comprises the reaction product of
A1) one or more saturated, aliphatic and/or aromatic di-, tri- or tetra-carboxylic acids or their anhydrides,
A2) one ore more diols and/or polyols,
A3) optionally, one or more hydroxycarboxylic acids, lactones, amino alcohols and/or aminocarboxylic acids,
A4) optionally, one or more (cyclo)aliphatic, olefinically unsaturated mono- or di-carboxylic acids and/or unsaturated diols and/or polyols,
A5) optionally, one or more monocarboxylic acids and/or monoalcohols and
a polyacrylate component B) that comprises the reaction product of
B1) one or more OH-group-free (meth)acrylic acid esters and/or vinyl aromatic compounds,
B2) one or more hydroxy-functional vinyl monomers or hydroxy-functional (meth)acrylic acid esters,
B3) one or more acid-group-containing monomers capable of free-radical copolymerisation, and
B4) optionally, one or more monomers capable of free-radical copolymerisation other than the compounds of components B1) to B3),
wherein
the polyester component A) has a hydroxyl number of from 180 to 300 mg KOH/g substance and an acid number of from 0.5 to 30 mg KOH/g, and the polyacrylate component B) has a hydroxyl number of from 10 to 180 mg KOH/g and an acid number of from 10 to 100 mg KOH/g, and the copolymer has an OH number greater than 27 mg KOH/g.

2. Aqueous copolymer dispersions according to claim 1, wherein the polyester component A) is obtained by polycondensation of structural units A1), A2) and A4).

3. Aqueous copolymer dispersions according to claim 1, wherein the polyester component A) contains the structural units A1), A2), A3) and A4) and has a double bond content (calculated as C═C, molar weight 24) of from 0.1 to 3.0 wt. %.

4. Aqueous copolymer dispersions according to claim 1, wherein the polyacrylate component B) is composed of a mixture of the structural units B1), B2) and B3).

5. Aqueous copolymer dispersions according to claim 1, wherein component B1) of the polyacrylate component B) is a mixture of at least one monomer B1) whose homopolymer has a glass transition temperature ≧40° C. and at least one farther monomer B1) whose homopolymer has a glass transition temperature <40° C.

6. Aqueous copolymer dispersions according to claim 1, wherein the polyacrylate component contains as component B3) compounds having ionic and/or potentially ionic groups.

7. Process for the preparation of the copolymer dispersions according to claim 1, wherein the polyester A) is placed in a water-miscible solvent and then, in a step (I), a hydroxy-functional monomer mixture (B′) of components B1), B2) and optionally B4) is added to the polyester A) and this monomer mixture (B1) has an OH number of from 12 to 350 mg KOH/g solid and an acid number of from 0 to 50 mg KOH/g solid, and in a second step (II) a further monomer mixture (B″) of monomers of components B1), B2), B3) and optionally B4) is added and this monomer mixture (B″) has an OH number of from 10 to 350 mg KOH/g solid and an acid number of from 50 to 300 mg KOH/g solid, and then the copolymer is dispersed in water, wherein the monomer amounts in steps (I) and (II) are to be so chosen that the ratio of the monomer mixture (B′) to the monomer mixture (B″) is from 10:1 to 1:2.

8. Process according to claim 7, wherein before, during or after the dispersion of the hydroxy-functional copolymers in water, at least some of the acid groups present are converted into their salt form by addition of suitable neutralising agents.

9. Aqueous coating compositions comprising aqueous copolymer dispersions according to claim 1 and at least one crosslinker reactive towards OH groups.

10. Two-component (2K) lacquers comprising aqueous copolymer dispersions according to claim 1 and at least one crosslinker selected from the group of the polyisocyanates.

11. Primers, fillers, pigmented or transparent finishing lacquers, clear lacquers, high-gloss lacquers and single-layer lacquers comprising the aqueous copolymer dispersions of claim 1.
